(19) United States
(12) Patent Application Publication
(10) Pub. No.: US 2010/0332468 A1
(43) Pub. Date: Dec. 30, 2010

(54) Spatial search engine support of virtual earth visualization system

(75) Inventor: Simon John Cantrell, Annapolis, MD (US)

Correspondence Address: SIMON JOHN CANTRELL, 1132 LAKE HERON DR #2B, ANNAPOLIS, MD, 21403, US

(73) Assignee: SIMON JOHN CANTRELL, ANNAPOLIS, MD (US)

(21) Appl. No.: 12/459,034

(22) Filed: Jun. 26, 2009

(51) Int. Cl. G06F 17/30

(52) U.S. Cl. 707/724; 707/706; 707/755; 707/E17.018; 707/E17.014

(57) ABSTRACT

A search engine enabling search criteria to be defined within a Virtual Earth visualization system. The search criteria can be entered directly as a “region-of-interest” and together with a number of optional text-based search criteria that are combined to become a spatial database query which is subsequently submitted to a spatial database whereby the search results are returned to the search client, for display directly into the Virtual Earth visualization system.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable.

### BACKGROUND OF THE INVENTION

The evolution of spatial database technology has come a long way since the emergence of relational database technology was first proposed by C. J. Date in the early 1970s. The Relational Database Management System (RDBMS) brought together an implementation of the concepts of relational models and file-based systems into a system capable of performing multi-dimensional relational database queries and returning data from a set of records which matched a set of search criteria. These result sets were returned from the database query as a set of records.

Today, spatial database queries are performed in much the same way, the difference being that the core relational model has been extended to include spatial information about an object, and this information is also included in the set of searched records. The corresponding search results also contain spatial information about the objects found and these search results are limited to only those objects which match the spatial search criteria.

Many systems exist today which enable the display of spatial objects, notably 3D mapping programs which are capable of harnessing the power of 3D graphics accelerator hardware and 3D graphics engines to provide efficient Visualization Systems, to display objects such as buildings, roads, map features, etc. Many of these systems provide search and query capabilities, but the implementation of an efficient system to search and retrieve spatial information seamlessly within the client program is an area which is in need of innovation.

The current NASA Data Active Archive Center(DAAC) System can provide extensive support for search and query of spatial data, but due to the considerable effort involved in acquiring the data products from the search results, and converting these into a form suitable for display on a 3D Visualization system, the current system is inefficient and due to the wide variability of data product format, often ineffective.

A scientist or data analyst, wishing to display coincident data sets, must first place an order on the DAAC system, via a search and order user screen. This is often assisted via a 2D geographic search window, which allows the definition of a search region using a roving rectangle over a standard map projection, typically showing the Earth displayed in the Mercator projection. Additional search criteria may be entered via user screen to limit the number of data sets returned. Then, following an initial search, a limited results set is returned to the user listing data sets which meet the search criteria. To further investigate whether these data will be useful for analysis, or scientific research, the user may open and view low-resolution browse images showing panchromatic images of the data sets. These are usually displayed in a separate window, for convenience. Once the user has viewed each browse image, in order to obtain high-resolution copies of the data, an order must then be placed, whereby the means to transfer the data is selected from a list. Either ftp transfer, or CD/DVD or tape medium may be selected. Then the order is placed, with any payment due, following with a considerable delay between when the user places the order and actually receiving the data. If the data is requested via ftp transfer, then it is transferred over the Internet into a directory location on the user workstation, or if via CD/DVD or tape medium, then it is sent via the US postal service. The file sizes are often in the hundreds of MB, so this is often the preferred method of transfer, in the current system. Only when the data sets have been received my the user, and are assembled in a convenient directory, can the user continue to view and display the data in the form necessary to provide a useful visual comparison. However, if the user receives the data in the native format, as saved by the ground processing system, then there may be an additional conversion step involved, whereby the appropriate data format conversion software must be obtained, or written, and perhaps even compiled, in order to prepare the data for display. It is noteworthy, that the visualization system is present in a different client program. Commonly, the native files may be displayed directly in Interactive Data Language (IDL), or MSSphinx, and these display the data in 2D to a given map projection, e.g. Mercator, or Miller Cylindrical, etc. Users often need to write scripts or programs to convert the data from the native format into a format suitable for display on modern 3D Virtual Earth Visualization systems. This is labor intensive and subject to errors.

Thus, the main feature of the proposed invention is to bring to together the key technologies of spatial databases and 3D Virtual Earth Visualization systems into a novel, integrated technology whereby the client program becomes the starting point and the finishing point for the spatial database query, hence eliminating the need for complex user interaction to convert a static geographical region of interest from its description, in terms of geographical coordinates, on entering the spatial query, and similarly, once the spatial query has been submitted to the spatial database and spatial results have been returned to the client program, to save the user the need to convert these results sets into a form suitable for display. A unique feature of the invention is the ability to enable the “region-of-interest” to be defined, modified and displayed spatially within the Virtual Earth visualization system. The invention brings together these conversion utilities, the spatial database and the display technologies into a new system capable of performing each of these steps seamlessly and dynamically hence, requiring the minimum of user input.

### FIELD OF THE INVENTION

The invention relates generally to the fields of spatial database technology and its interface with the emerging field of 3D Virtual Earth visualization technologies. There are many new systems which may benefit from the fusion of these technologies by the use of this invention.

### DESCRIPTION OF RELATED ART INCLUDING INFORMATION DISCLOSED UNDER 37 CFR 1.97 AND 1.98

Field of Search: 364/444; 364/463; 364/449; 364/200; 364/300; 340/995; 365/228; 701/200; 701/208; 701/209; 701/211; 707/3; 701/206; 707/10; 707/E17.018; 709/217;

### REFERENCES CITED

### U.S. Patent Documents

U.S. Pat. No. 4,630,209 December 1986 Audio/visual display system for multiple maps Takao Saito et al 364/444; 364/463; 364/449; 340/995; 340/996; 353/12;
U.S. Pat. No. 4,888,698 December 1989 Method for storing a parcelwise divided digital data base as well as of addressing a data parcel in mass memory, and apparatus for carrying out the method Driessen et al. 364/443; 364/200; 364/300; 340/995; 365/228;
U.S. Pat. No. 4,937,572 June 1990 Map display apparatus storing data of physically adjacent map sections in physically adjacent storage location Yamanda et al. 340/995; 340/990; 364/449;
U.S. Pat. No. 5,528,518 June 1996 System and method for collecting data used to form a geographic information system database Bradshaw et al. 364/561; 364/449; 364/560;
U.S. Pat. No. 6,047,280 April 2000 Interface layer for navigation system Richard A. Ashby et al. 707/2; 707/104; 340/990; 340/995; 701/200; 701/208; 701/209; 701/211;
U.S. Pat. No. 6,173,277 January 2001 Interface layer for navigation system Richard A. Ashby et al. 707/1; 701/208; 701/209; 345/440; 340/995;
U.S. Pat. No. 6,282,489 August 2001 Methods and apparatus for displaying a travel route and generating a list of places of interest located near the travel route Bellesfield et al. 701/201; 701/208; 701/209;
U.S. Pat. No. 6,363,320 March 2002 Thin-client real-time interpretive object tracking system Y Hong Chou 701/207; 340/988; 342/357.08;
U.S. Pat. No. 6,681,231 January 2004 Integrated information processing system for geospatial media Carl M. Burnett 707/104.1; 707/10; 707/200; 382/232; 382/305; 348/222.1;
U.S. Pat. No. 635,690 February 2004 Spatial intelligence system and method, Chen, Li-Wen 707/104.1*; 706/62; 707/E17.018;
U.S. Pat. No. 6,700,574 March 2004 Spatial data object indexing engine Yiping Song 345/423;
U.S. Pat. No. 7,202,801 April 2007 Method and apparatus for an automated location-based, dynamic notification system (ALDNS) Y Hong Chou; 340/994; 340/991;
U.S. Pat. No. 6,772,142 August 2004 Method and apparatus for collecting and expressing geographically-referenced data Kelling, et al. 707/3; 701/206; 707/10; 707/E17.018; 709/217
20040229595 November 2004 Method and apparatus for accessing a common database from a mobile device and a computing device Laursen et al. 455/403
U.S. Pat. No. 7,117,434 September 2006 Graphical web browsing interface for spatial data navigation and method of navigating data blocks Marcos Nogueira Novaes 715/272; 707/3; 707/5; 707/E17.142;
U.S. Pat. No. 7,228,316 June 2007 Three-dimensional volumetric geo-spatial querying Guillermo E. Gutierrez et al. 07/104.1; 707/100; 345/953; 382/240;
U.S. Pat. No. 7,266,560 September 2007 Parcelized geographic data with integral spatial indices and method and system for use and formation thereof 707/101; 701/200; 701/209; 340/990;
U.S. Pat. No. 7,321,826 January 2008 Point on interest spatial rating search Sheha at al. 701/209; 340/995.24; 342/357.08; 701/200;
U.S. Pat. No. 7,428,541 October 2008 Computer system, method, and program product for generating a data structure for information retrieval, and an associated graphical user interface Michael Edward Houle 707/100; 704/245; 707/102; 707/200; 707/3; 707/E17.008; 708/5;
U.S. Pat. No. 7,426,455 October 2008 Optimal boolean set operation generation among polygon-represented regions Richard T Antony 703/2; 345/443; 345/630; 382/226;
U.S. Pat. No. 7,466,244 December 2008 Virtual earth rooftop overlay and bounding Gur Kimchi et al. 340/995.1; 340/825.36; 340/990; 340/992; 340/995.17
U.S. Pat. No. 7,472,109 December 2008 Method for optimization of temporal and spatial data processing Katibah, et al. 707/3; 707/103Y; 707/E17.018

### BRIEF SUMMARY OF THE INVENTION

The key elements of the present invention are the capability of spatial search, based on a spatial or, object-oriented spatial database technology, a visualization system with the capability of being able to capture the users definition of a “region-of-interest”, in 3D within the client program, and also being capable of rendering the spatial data returned from a given query within the same visualization system, in a coincident manner.

### BRIEF DESCRIPTION OF THE SEVERAL VIEWS OF THE DRAWINGS

A better appreciation of the invention and many of the inherent advantages will be more readily apparent by reference to the detailed description and the accompanying drawings wherein:

FIG. 1 is a projected view of the “region-of-interest” displayed in 3D within the Virtual Earth environment;

FIG. 2 is a schematic representation of the spatial search engine of the present invention;

FIG. 3 is a projected view of the data set displayed in 3D within the Virtual Earth environment, having being returned from the spatial query, executed via the spatial search engine;

FIG. 4 is a view showing the input display device of the visualization system display screen, in an editing mode. The “region-of-interest” is shown to the right with the capability to drag the corner points to modify the regional coverage, also shown is an editing pane to the left, with a summary toolbar, including altitude editing controls;

FIG. 5 is a view showing the output display device of the visualization system display screen, with the search results set displayed. The “region-of-interest” is shown to the right with the results set from an MBRContains query, in this case: a MOD021KM data set; also shown is the query execution pane to the left, with a display toolbar, including search, “region-of-interest” and query execution display “check-box” controls;

FIG. 6 is a view showing the input display device of the visualization system display screen in a “search editing” mode. The “region-of-interest” bounding coordinates are shown in text boxes, where they may be edited. This screen shows the current spatial search criteria;

FIG. 7 is a view showing the input display device of the visualization system display screen in an “advanced search editing” mode. In addition to the “region-of-interest” bounding coordinates, the temporal search criteria and the other non-spatial search criteria are shown in text boxes, where they may be edited;

FIG. 8 is a view showing the input display device of the visualization system display screen in a “preferences editing” mode. The preferences for the “region-of-interest” type are shown in terms of a “pull-down” menu, which may be selected. This screen shows the current preference.

Drawings: 8 Drawings on 4 sheets to follow:

### ORIGIN OF THE INVENTION

This invention was arrived at via a series of steps: initially to respond to a need for an improvement in the ability to perform spatial queries within Virtual Earth visualization systems, and to display the results directly into the client program, rather than what is currently possible, where the results sets are returned as files or links to files, and a series of conversions is necessary in order to bring the data sets into the client program for display in the context of the “region-of-interest”. The innovation for the proposed invention is to enable each of these steps to occur seamlessly, and efficiently with the minimum of user interaction.

### DETAILED DESCRIPTION

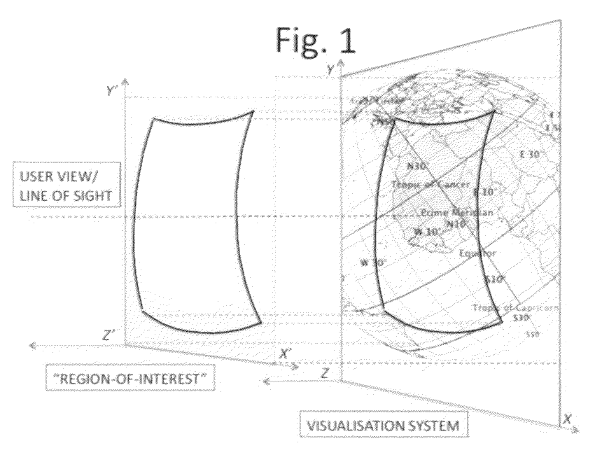

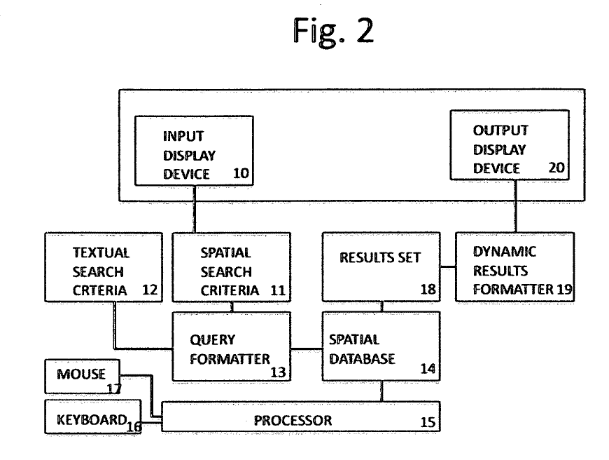

Referring to the drawings, and in particular to FIG. 1 a view of the “region-of-interest” displayed in 3D within the Virtual Earth environment is shown. A key concept of the “region-of-interest” is that it can be displayed in 3D over the Earth, and has geometric properties which are rendered accurately within the map projection of that Earth representation. FIG. 2 is a schematic representation of the spatial search engine of the present invention which is designated as System 1. FIG. 2 consists of an input display device 10, a set of spatial search criteria 11, a corresponding set of textual search criteria 12, if required, a query formatter 13 which combines the spatial and non-spatial (textual) components of the query into a format suitable for query execution, a spatial database 14 which is sent the spatial query and compares the records held within said database to the elements of the query to determine a match to the criteria, a processor 15 executes all, database and operating system commands, including user commands, which are generally sent via the keyboard 16 and mouse 17. The spatial database performs the spatial query, given a set of spatial criteria, and optionally, a non-spatial query, given a set of non-spatial (textual) criteria, and returns the result from that query into a results set. The results set 18 consists of the database records, which contain spatial information and non-spatial information from the records matching the criteria supplied. The dynamic results formatter 19 takes the query results sets and packages these into a language specific to the Virtual Earth visualization system, in the proposed invention, this is Keyhole Markup Language, which is recognized by the Open Geospatial Consortium Inc. (OGC). The final element in the Virtual Earth visualization system is the output display device 20, which is capable of rendering the spatial information contained within the results sets in 3D over the Earth, and ensures that their geometric properties are also rendered accurately within the map projection of that Earth representation.

The spatial search criteria 11 may be defined as a set of points, representing locations on the Earth, or above the surface, up to a given altitude. This is the “region-of-interest”. It can be represented in the Virtual Earth visualization system as a region in space and exists in the display system as a 3D box. Depending upon the orientation of the point-of-focus of the display system, it can be viewed as a bound region, either clamped to the Earth's surface or at an altitude above the Earth's surface. If it is represented above the Earth's surface, then all the space below is included within the search, i.e. the “region-of-interest” provides a regional definition of the space which data may be search for. Another aspect of the search is the dimension of time. If the data exists in that space for the time period of the search, then this further refines the criteria which are to be met. For example, data are only returned from a search if they fall within the space defined by the “region-of-interest” and within the time period defined by a time range. Further refinement of the search results set may be provided by means of additional parameters, including a data set name, description, campaign identifiers, and other tagged parameters. This set of items represents the corresponding textual search criteria 12.

In executing the spatial search a well defined set of spatial operators can be applied to compare the regions, i.e. the regions represented by the “region-of-interest” and the region represented by the data being searched. Since data may exist in a whole range of states in space, then the operators provide a well-established, formalistic way to determine the outcomes of a search, which provides rules for the spatial database to perform the spatial search. The Spatial Operators and their descriptions and syntax are found in the matrix of Table I below.

TABLE I
Spatial Operators

| Operator | Description | Syntax |
|---|---|---|
| Contains | Data may be wholly | Region A Contains Region |
| | contained by a region | B |
| Disjoint | Data falls outside a region, | Region A Disjoint Region B |
| | i.e. they do no intersect | |
| Equals | Data falls exactly within a | Region A Equals Region B |
| | region, i.e. they are | |
| | described by the same | |
| | region | |
| Intersects | Data may partly fall inside | Region A Intersects |
| | and partly outside a | Region B |
| | region, i.e. their regions | |
| | intersect | |
| Overlaps | Data overlaps a region, i.e. | Region A Overlaps Region |
| | their geometries intersect | B |
| | resulting in a geometry of | |
| | the same dimension but | |
| | not equal to either of the | |
| | two geometries | |
| Touches | Data touches a region, i.e. | Region A Touches Region |
| | that the interiors of the | B |
| | two geometries do not | |
| | intersect but that the | |
| | boundaries of the two | |
| | geometries intersect | |
| Within | Data falls within a region, | Region A Within Region B |
| | i.e. the opposite of | |
| | Contains | |

Similarly, the temporal data may be compared in a formalistic manner, to ensure the non-spatial database elements of the search may follow a set of well-established rules. These operators may be found in Table II below.

TABLE II
Temporal Operators

| Operator | Description | Syntax |
|---|---|---|
| > | Data may exist before a | Timestamp A > |
| | given time | Timestamp B |
| >= | Data may exist before a | Timestamp A >= |
| | given time, or at the same | Timestamp B |
| | time as a given time | |
| = | Data may exist at the same | Timestamp A = |
| | time as a given time | Timestamp B |
| <= | Data may exist at the same | Timestamp A <= |
| | time as a given time, or | Timestamp B |
| | after | |
| < | Data may exist after a | Timestamp A < |
| | given time | Timestamp B |

The other non-spatial search criteria, e.g. name, description, data quality, etc. may be searched within the database using conventional relational rules, which are not specifically the subject of this invention, but form an essential component of the success of the search, in terms of refining the search results, hence eliminating data sets not required.

A key aspect of the invention is the way in which the user interacts with the Virtual Earth visualization system in order to provide the spatial 11, and non-spatial search criteria 12 to the input display device 10. A variety of methods exist to define the “region-of-interest” for display within the visualization system. The bounding coordinates may be entered directly via the keyboard 16 and mouse 17, and saved into a Keyhole Markup Language (KML) file, or a default KML file may be displayed in the visualization system, which on selection of an edit mode, may be modified directly on the display via a set of handles, and stretched to a new shape. The resultant KML file, therefore, represents the desired “region-of-interest” and is saved in readiness for submission to the spatial database, as part of the spatial search criteria.

The remaining non-spatial search criteria are simply entered into text-boxes on the user interface, via the keyboard 16, and saved along with the spatial criteria in readiness for the query submission process. The next step in the process is handled by the query formatter 13, which provides the spatial 11 and non-spatial criteria 12 to the spatial database 14 in a format specific to that database and in a manner which allows for an expedient translation of the requirements of the search. The user is responsible for checking all the search criteria prior to executing the spatial query, and this is more readily achieved visually via the input display device 10, than in prior implementations of systems capable of performing spatial searches. Therefore an advantage of the proposed invention is that the 3D view of the “region-of-interest” may be examined via “fly-to” and “pan-and-zoom” functions which are readily available within the user interface. Other non-spatial criteria 12, can be reviewed via the user interface in the conventional way prior to query submission. For example, a search for a dataset may have science parameters tagged to it, or consists of 2D or 3D arrays of scientific values, i.e., weather forecasting data, where temperature, pressure, and humidity are science parameters which are commonly searched. These numeric values may be compared to maximum or minimum values or ranges of values, and for a given time period, this may define the non-spatial component of the search. An interesting aspect of the invention, which will enhance its usefulness, especially to science researchers and climatologists, is that with little effort, it will be possible to provide search criteria via the user input device to, for example, define a search region, and as part of the spatial criteria, include science parameters in terms of their maximums, or minimums, or both, for parts of that region. Hence, for example, for altitudes above 10,000 ft, it will be possible to define searches of relative humidity of >50%, etc. within the previously defined “region-of-interest” for the first week of January, in a given year. Here, it becomes clear that the query criteria can become quite complex and that the means to simplify the display of these are paramount in the 3D visualization system. Many of today's Virtual Earth visualization systems, e.g. Google Earth, NASA World Winds and ESRI ArcGlobe, and quite capable of rendering the search region, using colored representations of the “region-of-interest” in combination with a legend to indicate the desired datasets. The main aspect of the proposed invention is to facilitate the display of the “region-of-interest” and the query results sets, in terms which enable immediate recognition of the desired data, whether in terms of scientific values, or simply by tagging the data to a known orbit, or given time span or other data identifiers, but at all times to have each represented and displayed coincidentally in the same spatial reference space within the 3D Earth visualization system.

This is made possible by the inclusion of two key technologies: the query formatter 13 and the dynamic results formatter 19, in addition to the spatial database 14 which executes the spatial query.

The query formatter 13 is a complex computer program which is capable of accepting a wide variety of parameters, including, but not limited to the set of spatial search criteria 11 and non-spatial search criteria 12, and formulating a correctly formatted spatial database query suitable for submission to the spatial database 14. The query formatter 13 needs to have complete knowledge of the expected syntax, therefore allowing the widest range of variability of user-defined search criteria. Therefore it encompasses the ability to take the spatial “region-of-interest”, in terms of its geographical coordinates: latitudes, longitudes, latitudes, and the temporal time-ranges, in terms of beginning dates, times, and ending dates, times and a wide range of parameters, including, but not limited to data set names, descriptions, science parameters, and other attributes which maybe tagged to the data, and packaging these into a form to be directly sent to the spatial database 14.

The spatial database 14 is now a standard commercially available spatial database application, containing all the datasets which are subject to search. Typically, these will consist of thousands or even millions of records, which are time stamped, and populated from a myriad of data sources, including climate modeling programs, radar, lidar sensors, airborne and satellite-borne sensors, and detectors, e.g. those which reside on NOAA's GOES, POES instruments, and other sources, such as NASA's EOS Mission: MODIS, MOPITT, MISR, TRMM, SAGE instruments, etc. Many data sets which are released hourly, or daily by the National Weather Service include data sets which hold information about atmospheric conditions, i.e. temperature, pressure, relative humidity, at various geopotential heights are available for storage within the spatial database 14. With the next generation of high-spectral resolution sensors, IASI, NPP, NPOESS, there will be an order of magnitude increase in the volume of data which is available for storage within a spatial database 14, and may be searched. This is in addition to the more conventional data, e.g. census data held by the National Census Bureau, including populations, ethnicity, profession, etc. These, although more traditionally known by their 2D spatial geometries, are also a rich source of data for comparison with 3D data sets. So, if a scientist seeks to learn which populations will be affected by a upcoming volcanic eruption, a search of the path of the smoke plume, and the extent of the dispersion over an area may lead to a typical definition of the “region-of-interest”. The results set from such a search may contain the populations, addresses, land parcels, rivers and tributaries, counties, towns and roads connecting them, which will be subject to contamination by the smoke plume.

An added benefit of the proposed invention, is that after the event, where a volcanic eruption has taken place, each day the progress of any smoke plume may be tracked, via a spatial search, which is refined by the addition of temporal search criteria, and the concentrations of smoke particles, may be displayed directly within the “region-of-interest”, from within the output display device 20. At this point it is worth noting the relationship between the input display device 10 and the output display device 20. Although to the computer processor 15 these are represented internally as distinct entities within its memory space, these may appear to the user together as part of one common visual interface. The merit of the proposed invention is the ability to represent these as layers or 3D visualizations within the Virtual Earth 3D visualization system and is key to providing immediate visual confirmation to the user that the data sets returned as part of the spatial query indeed reside within the “region-of-interest”, or bear a relationship to that region as described by the various combination of spatial operators within the spatial query. However, in this process description, the input display device 10 and the output display device 20 will be handled as discrete entities, due to their relative positions in the processing chain, as shown in FIG. 2. For simplicity, they may be considered as layers or regions-in-space coincident within the user client program.

The dynamic results formatter 19 is an essential innovation for the proposed invention, comprised of a complex computer program, capable of accepting a widely varying set of query results, each containing spatial geometries, besides a set of non-spatial information, dependent upon the initial search criteria provided, and formatting these results “on-the-fly” into a form which is directly suitable for display within the Virtual Earth virtualization system. This program has full knowledge of the types and formats of the range of possible results sets, including essential spatial geometries, in terms of latitude, longitude, and altitude information describing the regions occupied by the data sets matching the spatial search criteria. It also has knowledge of how to interpret the various temporal and science parameters tagged to the data, and significantly, how to display these within a geo-referenced, 3D Virtual Earth visualization system, e.g. Google Earth, or NASA World Winds. The information is commonly encapsulated within the Keyhole Markup Language format, and the merit of the proposed invention is that the dynamic results formatter 19 can construct a correctly formatted KML file, containing said results sets and immediately display these directly on the output display device 20. The resultant display shows, where appropriate, coded information about the data, using colors within the rendered graphics to represent e.g. science parameters, e.g. temperature, pressure, relative humidity of the climate data sets. It becomes immediately apparent to the user where the data sets of interest exist in space and time, in the context of the display, with the geo-referenced data displayed coincident to the original user provide “region-of-interest”. A commonly used geo-referencing standard is WGS-84. This is the geo-referencing system used in the Google Earth Visualization system. Many systems today require the user to perform a series of steps prior to the display of the results sets. Sometimes this may involve the user obtaining the data set in a native format, from a separate search, and then also obtaining the format convertor computer program, which then is run on the data set to convert it into a form suitable for display. Typically, these programs are run at a separate time, from the search, or on a separate computer processor, and only then can the results sets be displayed. The proposed invention has the distinct advantage that the logic required to perform this series of conversions and display steps is contained within the query formatter 13, with its knowledge of the spatial 11 and non spatial search criteria 12, and the dynamics results formatter 19, with its knowledge of the requirements of the output display device 20.

The computer processor 15 needed to provide the hardware environment to perform all the steps in the spatial search is a standard commercially available desktop or laptop computer, if the number of records is low, i.e. in the hundreds or thousands and the data sets are relatively small, i.e. only a few kilobytes or megabytes for each record. However, is the number of records is extensive, i.e. in the tens of thousands or millions, and the data sets are relatively large, i.e. tens or hundreds of megabytes each, then high-performance data-blade systems, or high-performance computing facilities will be required to host the spatial databases. The other entities which have complex computer programs are the query formatter 13 and the dynamic results formatter 19, and although complex, these can comfortably reside on a client system, whether a desktop or laptop computer.

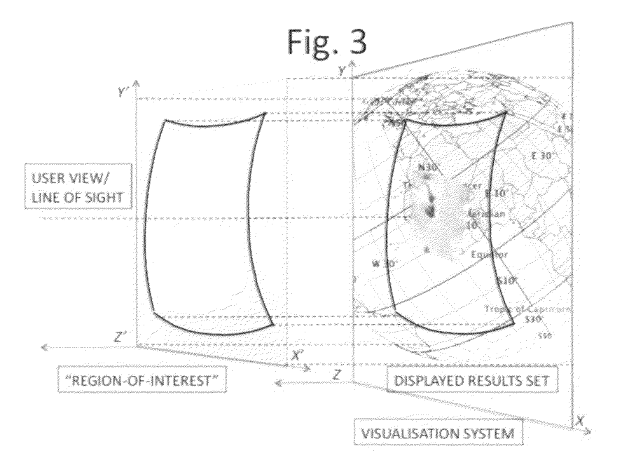

Referring to FIG. 3, on completion of the query execution, which in the current valid spatial search takes a matter of a fraction of seconds to return the results sets and display these within the “region-of-interest” a data set which matches the spatial and non-spatial search criteria is displayed. The valid data set is a MOD021KM dataset which corresponds to the radiometric values across the panchromatic part of the electromagnetic spectrum, during an overpass of the region. This valid data is located within the region defined by a Northern latitude valid northing value of 70.0 degrees, a Western longitude valid easting value of 40.0 degrees, an Eastern longitude valid easting value of 90.0 degrees, and a Southern latitude valid northing value of 40.0 degrees, and within a time range between 0710Z and 0720Z on May 20, 2001. The valid data set also has metadata tags which represent a Day/Night flag set to “Day”, and a Short Name of “MOD21KM”. The actual timestamp of the valid data set returned is 0715Z, which is within the time range of the valid temporal search criteria. Thus, the valid data set, which is returned from the spatial database, via the query results formatter, is displayed in a correctly geo-referenced manner within the original “region-of-interest”, virtually instantaneously.

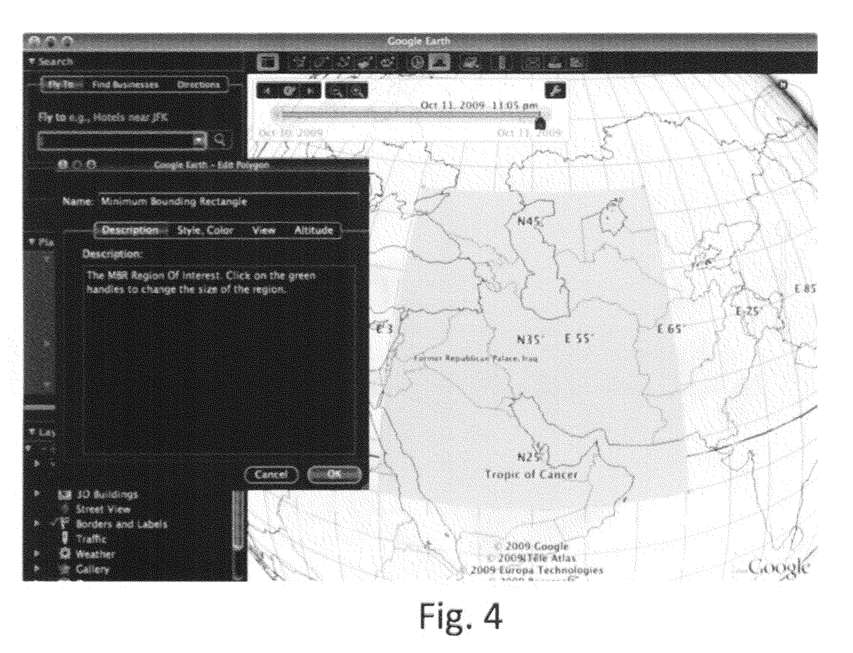

Referring to FIG. 4, the spatial search criteria may be edited graphically from within the client program. This can be achieved, for example, by clicking and dragging the coordinates which define the region, which can be saved, in preparation for query execution. Note also, the Altitude may be adjusted via the pane shown to the left, by clicking on a tab and using the controls to adjust the desired level.

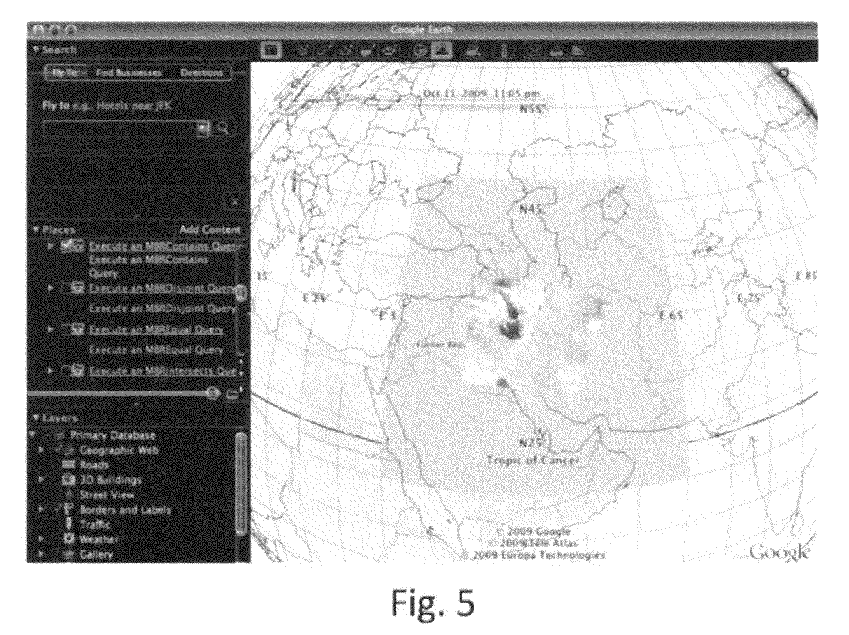

In the Places pane of the user screen shown in FIG. 5, there are a set of check-boxes shown, including those corresponding to “Search”, “Region Of Interest”, “Execute an MBRContains query”, etc. These control the items displayed in the pane to the right, which depicts the Virtual Earth and the “region-of-interest” and any data sets which have been returned from a spatial query. In this example, a single data set is shown within the “region-of-interest”, with the spatial query execution having being launched by simply clicking on the desired query type. It will become apparent in FIG. 5, that each of the spatial operators listed in Table I, have a corresponding query type in the menu list, i.e. by checking the box labeled “Execute an MBRContains query” the user may initiate the query with the syntax: “Region A Contains Region B”, where Region A is represented by the “region-of-interest” and Region B is represented by the spatial geometry of each of the records in the spatial database, which are compared in turn during the execution of the query. Those which logically meet the tested criteria are collected together and saved into the results set, prior to conversion into a Keyhole Markup Language file.

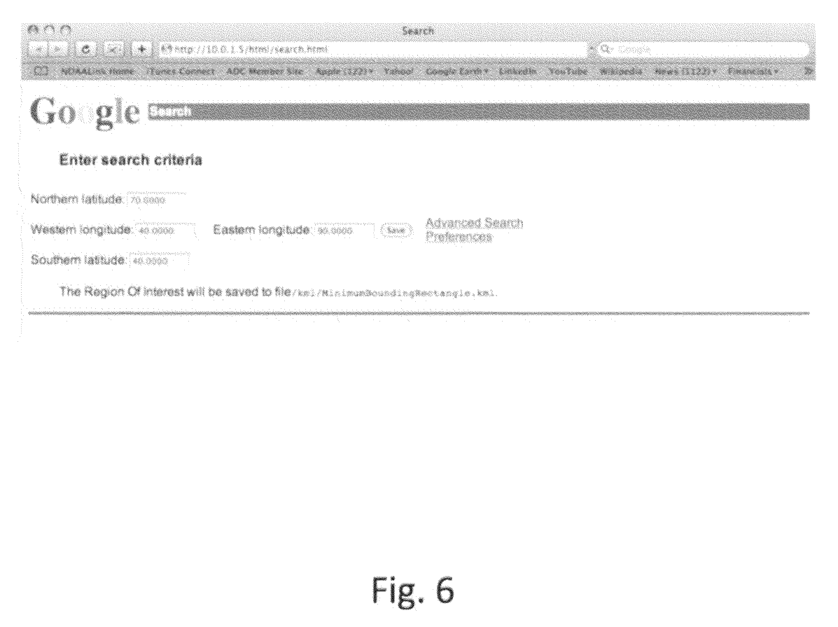

In addition, referring now to FIG. 6, the current spatial search criteria 11 for the current search example are read from the file defining the “region-of-interest” and these are also editable via text boxes from a user entry screen. The current valid spatial search criteria are also shown in alphanumeric form below the “Enter search criteria” label. Thus, the Northern latitude valid northing value is 70.0 degrees, the Western longitude valid easting value is 40.0 degrees, Eastern longitude valid easting value is 90.0 degrees, the Southern latitude valid northing value is 40.0 degrees. This, these bounding ordinates mark out a “region-of-interest” which is within 70 and 40 degrees N and 40 and 90 degrees E.

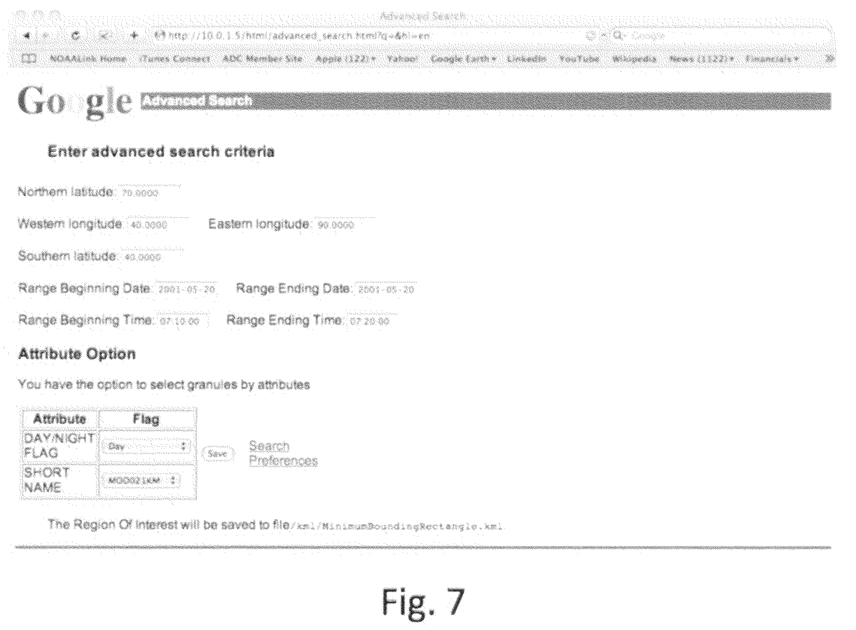

Referring to FIG. 7, the “advanced search” user screen, both the current spatial search criteria 11 and non-spatial search criteria 12 also editable via text boxes from a user entry screen. Here we examine how the user can enter these criteria via the input display device in preparation for the query execution. Besides the spatial search criteria 11, each additional search term, i.e. the temporal search criteria and the other non-spatial search criteria 12 further refine the search, and hence reduce the number of records returned in the results set. The current valid spatial search criteria are also shown in alphanumeric form below the “Enter advanced search criteria” label. Thus, the Northern latitude valid northing value is 70.0 degrees, the Western longitude valid easting value is 40.0 degrees, Eastern longitude valid easting value is 90.0 degrees, the Southern latitude valid northing value is 40.0 degrees. Below are shown the valid temporal search criteria. Thus, the valid Range Beginning Date value is “2001-05-20” and the valid Range Beginning Time value is 0700Z, and the corresponding valid Range Ending Date is “2001-05-20” and the valid Range Ending Time value is 0720Z, i.e. a time range between 0710Z and 0720Z on May 20, 2001. Also shown are the select non-spatial search criteria. These are also shown in alphanumeric form below the “Attribute Option” label. The valid Day/Night Flag is selected as “Day” and the valid Short Name is selected as “MOD021KM”.

Referring to FIG. 7, the “advanced search criteria” user screen, this provides a convenient way to enter the spatial and non-spatial search criteria. Note that in the example, besides the spatial search criteria: north, west, east, and south coordinates, and the temporal criteria: range beginning date, range beginning time, range ending date, range ending time, there are the non-spatial search criteria: day-night flag, short name. Only a select few non-spatial search criteria are shown, but this list may be expanded to further refine the search, hence reducing the number of records returned within the results set. Various non-spatial criteria, for example, a day-night flag can allow selection of just those data sets which occur during the day, or at night or both, when the spatial coverage straddles the earth's terminator. The selection of a short name further limits the data sets returned in the query to just those with a matching short name. This list of non-spatial search criteria may be an extensive list, containing many terms. This is especially important when the spatial database contains many records, which in many cases have the same spatial and temporal information, i.e. they exist as data in the same time and space relative to the Earth, but can only be distinguished by other unique features, e.g. name, description, data quality, data type, etc. For a visualization system which is capable of rendering many records at once for display at high-resolution, it is left to the user, which final results are displayed. In the current invention, this may be achieved by simply checking the “check-box” adjacent to the results data set name, as shown in FIG. 5.

The spatial search criteria 11 are typically represented via bound “region-of-interest”, however due to the nature of the variations in geometries it is also possible to define points, and lines to represent alternate definitions for the “region-of-interest”. So, for example, a search could be initiated which requires all data sets containing information about temperature up to 5,000 ft, which intersect the equator on the first day of Spring of 2008 to be returned in the search results set.

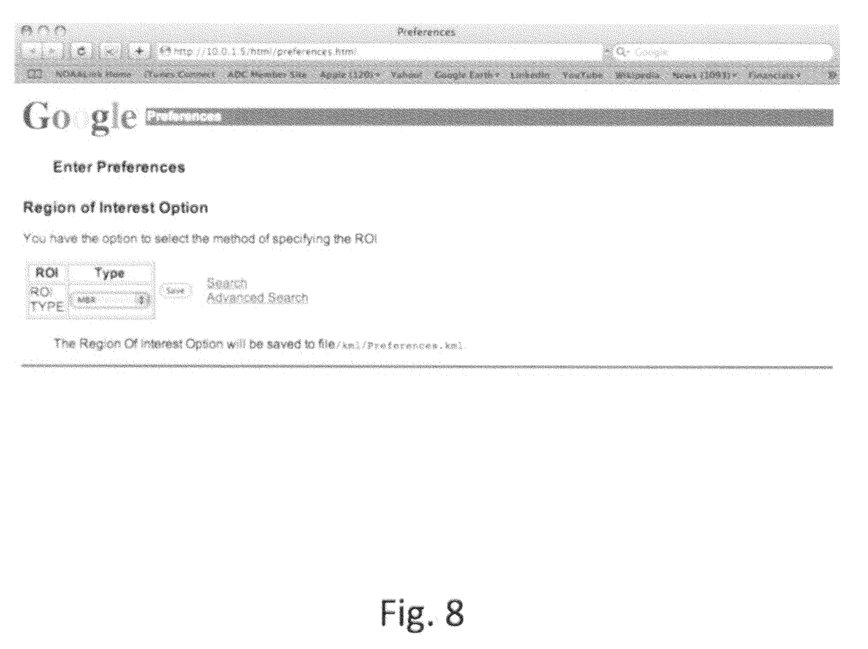

Referring to FIG. 8, the “region-of-interest” type may be selected via a pull-down menu. The choice of how this is to be defined is given as “MBR”, i.e. Minimum Bounding Rectangle, “Point”, “LineString”, etc. This user screen provides a convenient way to select and save the choice of the “region-of-interest” type out to a Keyhole Markup Language file, storing the user preferences for the search. The current valid “region-of-interest” type is shown in alphanumeric form below the Region of Interest Option label. The valid ROI Type value is selected as “MBR”. Thus the “region-of-interest” type is a bound region.

When the user executes a spatial search all the relevant spatial 11, temporal, and non-spatial 12 search criteria and the “region-of-interest” preferences are read by the query formatter 13 program, which combines these into a correctly formatted query statement, which is subsequently passed into the spatial database 14 as a spatial query.

Current spatial search systems providing comparable functionality, i.e. NASA's Data Active Archive Centers (DAAC), provide a spatial and textual user interface for the user to define and save the search criteria 11, 12 prior to submitting a spatial query, however, the limitation is that the spatial query can only be displayed in limited 2D map display, with a search “region-of-interest” having only a bounding rectangle, rather than a range of geometries, which is a capability of the proposed invention. Also, once the query is submitted, then the time taken for the search to execute varies between a few minutes and a few hours, and once complete the results sets are often returned in the format native to the processing or collection method. For example, if the user requested CERES data, which contains 3D information of cloud structures, during the Hurricane season, of fall 2004, over the Eastern seaboard, then the results would be encoded in a Hierarchical Data Format (HDF) and listed over the range of dates selected, and each would need to be downloaded on the user desktop or workstation, for reformatting, and data conversion, prior to display on a user display program which is capable of rendering the reformatted, spatial data sets.

In the proposed invention, all the above steps occur within the spatial search engine system, and results data sets are displayed directly into the same 3D Virtual Earth visualization system as the initial “region-of-interest” was defined. An advantage of the invention, is that if a NASA scientist, or NOAA/National Weather Service investigator, wanted to compare data sets, which reveal different structures within a spatial region of the atmosphere, say by comparison of NEXRAD radar data with, CERES data, which contains structural information about clouds, this could be done in-situ, with coincident data represented simultaneously within the Virtual Earth visualization system, supported by the Spatial Search Engine, configured in the manner described herein.

As developed, the spatial search engine support of Virtual Earth visualization system will include new data from the NEXRAD, existing data from NASA's EOS DAACs, and data from the NPP/NPOESS systems, i.e. NASA's SDS and NOAA's NSOF, as it becomes available. It is anticipated that all this data may be added to the present system via new ingest software technology, and the corresponding addition of storage capacity sufficient to contain the new data.

Thus the details of the invention have been described, in terms of the essential key elements, which may be implemented in a variety of ways, but must include in each, a way which allows seamless provision of the search criteria, in terms of the “region-of-interest” and the display of the spatial results set, in terms of its spatial information in relation to the surrounding region. This may be geo-referenced to the exact latitude, longitude, altitude, and time and displayed in a form most readily useful for the user.

What is claimed as new and desired to be secured by Letters Patent of the United States is:

1. An efficient method of enabling a spatial database query to be captured and submitted to a spatial database, via a client program, whereby results are returned for display within a 3D Virtual Earth visualization system, comprising:
(a) visual display client, allowing a “region-of-interest” to be defined and displayed spatially within the Virtual Earth visualization system;
(b) spatial search engine query formatter capable of receiving spatial queries and submitting these to a spatial database;
(c) spatial database which searches a set of records for spatial matches to the spatial query provided, returning a search result;
(d) spatial result set formatter (parser), capable of dynamically interpreting the query content and providing these in a form suitable to be directly displayed within the Virtual Earth visualization system;
(e) visual display client, allowing a spatial result set, consisting of data sets with spatial geometries to be displayed spatially within the Virtual Earth visualization system;

2. The spatial search engine of claim 1 including a query execution check-box capable of executing a spatial database query which returns a results set containing a subset of the data sets contained within a spatial database meeting a specific set of spatial and non-spatial criteria, and limits the display to just those results returned to the output display device, which forms part of a Virtual Earth visualization system.

3. The spatial search engine of claim 1 including a display of the “region-of-interest” which represents the search region, rendered within the input display device, which forms part of a Virtual Earth visualization system.

4. The spatial search engine of claim 1 including a “region-of-interest” modification mode, which is enabled by the selection of a set of editing handles, or points, from within the display of the search region, rendered within the input display device, part of a Virtual Earth visualization system.

5. The spatial search engine of claim 1 including a user entry screen for the spatial search criteria within the input display device, which forms part of a Virtual Earth visualization system.

6. The spatial search engine of claim 1 including a user entry screen for the temporal and non-spatial search criteria within the input display device, which forms part of a Virtual Earth visualization system.

7. The spatial search engine of claim 1 including a user entry screen for the preferences of the “region-of-interest” type within the input display device, which forms part of a Virtual Earth visualization system.

8. The spatial search engine of claim 1 including a display of the results set within the output display device, which forms part of a Virtual Earth visualization system.

9. The spatial search engine of claim 1 including a query formatter being a complex computer program which takes the spatial search criteria together with the textual and non-spatial search criteria and formats these into a syntax suitable for the spatial database, which is running on the computer processor.

10. The spatial search engine of claim 1 including a spatial database which contains all searchable records for comparison to the spatial search criteria and the temporal and non-spatial search criteria.

11. The spatial search engine of claim 1 including a dynamic results formatter which is capable of translating the results set into a form suitable for graphical display within the output display device, which forms part of a Virtual Earth visualization system.

12. The spatial search engine of claim 1 including a computer processor which is capable of executing the spatial query within the spatial database to produce the results set. The computer processor is also capable of displaying both the input display device and the output display device from within the Virtual Earth visualization system, although these are not necessarily run on the same device as the spatial database and the query formatter and dynamic results formatter computer programs. These tasks may be split across several computer processors, dependent on the computing workload.
The spatial search engine in support of Virtual Earth visualization system provides systematic, highly configurable, provision for user definition of a “region-of-interest”, including bounding coordinates, or, if point data, or line-string, its regional coordinates, and within the context of the 3D visualization system, provide a comprehensive spatial search system, capable of executing a wide variety of Open Geospatial Group (OGC) compliant spatial queries, using any of the spatial operators shown in Table I, together with temporal operators shown in Table II, and other user selected non-spatial search criteria yielding a limited, highly relevant results set containing desired data, which is displayed, in 3D within the original “region-of-interest” for purposes of inspection and visual analysis. The potential applications for the proposed invention are wide and numerous. If the system was to be implemented on a desktop computer with a Virtual Earth visualization system running on the user account, and a separate processor was available to store and execute spatial database queries, then query response times would be relatively short, of the order of seconds or minutes. With the availability of distributed computing, including the Internet, spatial queries can be initiated from a user's desktop, and query results sent back to a query formatter program running on the same desktop processor. The proposed invention can be configured for execution in a wide variety of processor configurations, dedicated to the best computing performance, to execute the required processor workload, provided each of the elements illustrated in FIG. 2 are present in the system.
Examples of potential applications include, the calibration and validation of spatially coincident data sets, for instance with the upcoming availability of the NPP/NPOESS data, new higher resolution data from these instruments will need to be radiometrically and geometrically compared with existing data sets, like those which are currently available within the NASA EOS DAAC's, or NOAA's NGDC. The validity of the new data streams require calibration, prior to acceptance by the user community, especially if the data forms part of any work with any scientific merit. One such undertaking is NOAA's quest to perform decadal climate trend analysis. Here many scientific parameters, including C0², sea-surface temperature, acidity, humidity, rainfall, land surface temperature, polar ice cap extent, ozone, etc. are subject to trending analysis, whereby climatological models are compared with satellite data to reveal upturns, peaks, downturns and troughs in these various scientific indicators over many decades, dependent upon the variability of the data. Much of that data possesses spatial information, and bears scientific fruit if the convenience of the search and visualization system can be extended to allow a simplified means to perform reliable and meaningful comparison of spatial data.
Another potential application is now possible with the availability of significant processing power within hand-held personal digital assistant (PDA) devices. For example, the Apple iPhone is capable of rendering a “region-of-interest” and a data set which possesses spatial geometry, together within a limited Virtual Earth visualization system, e.g. Google Earth. The present invention can be extended to include a PDA, in place of the desktop computer, as the processor necessary to render the Visualization system, thus the input display device, the spatial search criteria, and the temporal and non-spatial search criteria can be stored and sent from the client program running on the PDA. The results sets can be returned directly onto the PDA for display within the output display device. The remaining elements of the system, including the query formatter, the dynamic results formatter can also reside on the PDA, while the spatial database may remain on a desktop or server computer for better query performance. This configuration will enable workers in the field, to harness the real power of distributed computing, while working directly on a task. Vulcanologists who are attempting to predict or track the smoke plumes during a volcanic eruption can see the plume grow over the period of the eruption, even during inclement weather, as the smoke and ash particles are sampled during successive satellite overpasses.
Another example of a potential application, is the correlation of exo-atmosphere weather events in response to changes in Earth's magnetic fields. High altitude data showing proton flux, or electron flux is now available from GOES instruments, and at times which space weather events occur, variations in the fluxes are detectable, and often lead to a massive effect on utility grids, or affect the safe passage of polar flights. The proposed invention allows quick data dissemination, whereby a high-altitude “region-of-interest”, perhaps representing a commercial jet flight plan, can be defined in the user client program, and the searchable space weather data can be quickly rendered into the 3D visualization system allowing diagnosis of the viability of the plan. This could assist in the prevention of unnecessary exposure to the radiation which penetrates the Earth's atmosphere near the polar regions.
